(19) United States
(12) Patent Application Publication
(10) Pub. No.: US 2021/0344108 A1
(43) Pub. Date: Nov. 4, 2021

(54) A Broadband Antenna Composed of Lines and Its Application

(71) Applicant: Innovation Sound Technology Co., LTD., Guangdong (CN)

(72) Inventors: Shunming YUEN, Guangdong (CN); Wai Yin MUNG, Guangdong (CN); Ka Ming WU, Guangdong (CN)

(21) Appl. No.: 16/610,981

(22) PCT Filed: Aug. 29, 2018
(86) PCT No.: PCT/CN2018/102929

§ 371 Date: Nov. 5, 2019

(30) Foreign Application Priority Data
Aug. 24, 2018 (CN) 201810974054.6

(51) Int. Cl. H01Q 1/36

(52) U.S. Cl. CPC H01Q 1/36

(57) ABSTRACT

The present invention discloses a broadband antenna composed of lines, comprising a top metal sheet, a bottom metal sheet, and a plurality of lines that are arranged equidistantly in parallel, and attached unto the top metal sheet. The broadband antenna proposed in the present invention is composed of a plurality of lines attached onto a metal sheet. Different antenna frequencies may be obtained by changing the length of the lines. In this way, antennas of lines with different lengths can be designed according to the characteristics of the short-range radio technology, and the matching application of several short-range radio technologies, such as Bluetooth, ZigBee and cellular communication, can be achieved.

### FIELD OF THE INVENTION

The present invention relates to the field of wireless communication technologies, and in particular to a broadband antenna composed of lines and its applications.

### BACKGROUND OF THE INVENTION

The Internet of Things (IoT) refers to the interconnection and exchange of data between devices/sensors. At present, with the explosive growth of Internet of Things technology, more and more practical applications can be found in many fields, including security, asset tracking, agriculture, smart metering, smart city and smart home. IoT applications have specific requirements such as long distances, low data rates, low power consumption and cost effectiveness. Widely-used short-range radio technologies (e.g., ZigBee, Bluetooth) are not suitable for scenarios that require a long-distance transmission. Solutions based on cellular communications (e.g., 2G, 3G, and 4G) can provide a greater coverage, but they consume excessive device power. Therefore, the current solution is to integrate various short-range radio technologies (e.g., ZigBee, Bluetooth, and cellular communications (e.g., 2G, 3G, and 4G)) for use. As a consequence, a broadband antenna is required for the communication between the above two types of technologies, and also for external transmission and reception.

### DESCRIPTION OF THE INVENTION

The present invention aims to provide a broadband antenna composed of lines, and its application to solve the problem brought up in the above background technology.

To achieve the above object, the present invention provides the following technical schemes:

A broadband antenna composed of lines, comprising a top metal sheet, a bottom metal sheet, and a plurality of lines that are arranged equidistantly in parallel and attached unto the top metal sheet.

As a further scheme of the invention, the distance between the top metal sheet and the bottom metal sheet is 2 mm.

The application of a broadband antenna composed of lines in the short-range radio technology.

Compared with the prior art, the beneficial effects of the present invention are as follows:

The broadband antenna proposed in the present invention is composed of a plurality of lines attached onto a metal sheet. Different antenna frequencies may be obtained by changing the length of the lines. In this way, antennas of lines with different lengths can be designed according to the characteristics of the short-range radio technology, and the matching application of several short-range radio technologies, such as Bluetooth, ZigBee and cellular communication, can be achieved.

### BRIEF INTRODUCTION OF THE DRAWINGS

FIG. 1 is a structural schematic diagram of a broadband antenna composed of lines.

FIG. 2 is a diagram showing simulation results of feedback losses, in different lengths of lines, of the antenna in the present invention.

FIG. 3 is a diagram showing the test and simulation results of the antenna in the present invention.

### DETAILED EMBODIMENT

The technical scheme in the embodiment of the present invention will be clearly and completely described as follows with reference to the accompanying drawings. Apparently, the described embodiments are only a part of that of the invention, and not all of them. All other embodiments obtained by those skilled in the art based on the embodiments of the present invention without making creative efforts shall fall within the scope of protection of the present invention.

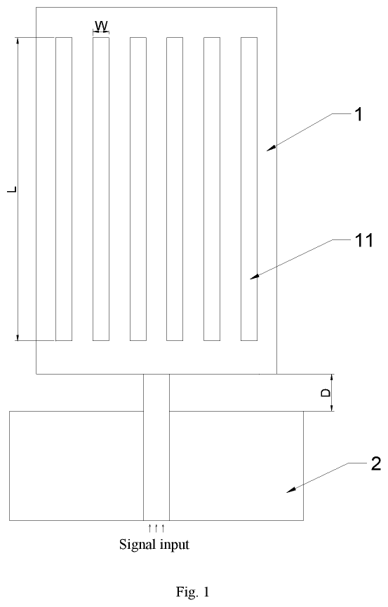

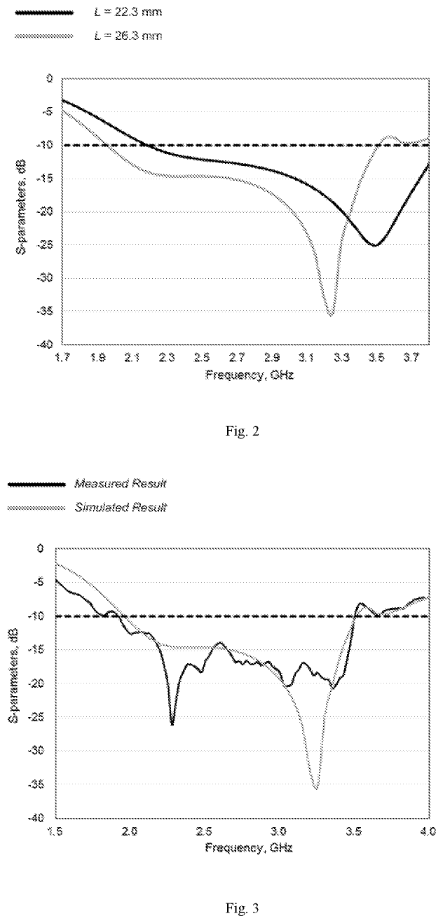

Refer to FIG. 1 for a broadband antenna, proposed in the embodiment of the present invention, composed of lines contains a top metal sheet 1, a bottom metal sheet 2, and a plurality of lines 11 that are attached onto the top metal sheet 1 and equidistantly arranged in parallel. The distance between the bottom of the top metal sheet 1 and the top of the bottom metal sheet 2 is 2 mm.

FIG. 3 shows the simulation result of return loss (feedback loss) input by the broadband antenna with the same width W (1.5 mm), the length L of two sets of lines 11 being 22.3 mm and 26.3 mm respectively, which represents the resonance operating frequency of the antenna. FIG. 4 shows the test and simulation result of the broadband antenna with the length L of line 11=26.3 mm and the width W=1.5 mm.

It can be seen from the simulation results that with a shorter L, the broadband antenna will shift to a higher frequency, and thus the broadband antenna can cover different radio frequencies. Therefore, different antenna sizes can be designed according to the product itself, and the effect of matching different radio technologies (GPS, Bluetooth, ZigBee, cellular communication, etc.) can be achieved.

For those skilled in the art, apparently the present invention is not limited to the details given in the above exemplary embodiments. The present invention can be embodied in other specific forms without departing from the spirit or essential characteristics of the invention. Therefore, the embodiments shall be considered as exemplary and unrestricted in any way. The scope of the invention is defined by the appended claims rather than the above description. Hence, all changes intended to come within the meaning and range of equivalent elements of the claims shall be included within the invention. Any marks on drawings to the Claims shall not be construed as limiting the Claims involved.

Furthermore, it shall be understood that although the Specification is described in terms of embodiments, not every embodiment includes only one independent technical scheme. The description style in the Specification is for clarity only. Those skilled in the art shall take the Specification as a whole. The technical schemes in various embodiments may also be combined as appropriate to form other embodiments that can be understood by those skilled in the art.

1. A broadband antenna composed of lines, comprising a top metal sheet, a bottom metal sheet, and a plurality of lines equidistantly arranged in parallel and attached onto the top metal sheet.

2. A broadband antenna composed of lines according to claim 1, wherein the distance between the top metal sheet and the bottom metal sheet is 2 mm.

3. The application of a broadband antenna composed of lines according to claim 1 in the short-range radio technology.

4. A broadband antenna composed of lines according to claim 1, wherein the length of several lines attached onto the top metal sheet can change the operating frequency; with long lines, the operating frequency is reduced.
